(19) United States
(12) Patent Application Publication
(10) Pub. No.: US 2010/0162856 A1
(43) Pub. Date: Jul. 1, 2010

(54) Multi-head rachet wrench

(76) Inventor: Ching-Jih Hsiao, Taichung County (TW)

Correspondence Address: Ching-Jih Hsiao, P.O. Box 44-2049, Taipei, 10668, TW

(21) Appl. No.: 12/318,353

(22) Filed: Dec. 29, 2008

(51) Int. Cl. B25B 13/46

(52) U.S. Cl. 81/60

(57) ABSTRACT

The present invention provides a kind of multi-head rachet wrench, featuring a function for joint with sleeves of different specifications through two or more sleeve joint structures configured on the rachet wrench; In its structural design, a broad part is configured on both the front and back end of the wrench shaft to fit the rachet sleeve joint, and a one-sided or double-sided rachet sleeve joint device is configured respectively on each broad part; Also, each joint is configured with different sizes and specifications, so that sleeves of multiple specifications can work on one single rachet wrench.

### BACKGROUND OF THE INVENTION

(1) Field of the Invention

The present invention relates generally to a kind of multi-head rachet wrench, and more particularly to a multi-sleeve joint structure which allows sleeves of various specifications to be fitted on one single wrench.

(2) Description of the Prior Art

FIG. 1 shows the structure of a general rachet wrench that is commonly seen at present. The rachet wrench 10 has a wrench shaft 11, a handle 12 for the user to hold on the back end, and a rachet sleeve joint 13 structure on the front end; the sleeve joint 13 shall be coupled with a sleeve of the same specification before operation.

However, the structural design of the above traditional rachet wrench may lead to the following shortcomings:

Firstly: The traditional rachet wrench is only configured with one joint structure. When the sleeve to be coupled is of a different specification or size, the whole rachet wrench has to be replaced. This not only causes inconvenience in operation, but also increases difficulty in operation and low efficiency.

Secondly: If one wrench can only match sleeves of one single specification, the user must purchase multiple wrenches in case sleeves of multiple specifications are demanded. This not only causes inconvenience in operation, but also increases purchase cost. Consequently, the purchase intention of the consumers may be adversely affected. Hence, a solution to overcome the above shortcomings is necessary.

### SUMMARY OF THE INVENTION

In view of the shortcomings of prior-art rachet wrench in usage, the inventor has developed the present invention after deliberate research and improvement. The present invention adopts a new structure of a multi-head rachet wrench as shown in FIG. 2 to make the product very convenient in usage.

A kind of multi-head rachet wrench, mainly comprising:

a wrench shaft, configured with a broad part on both the front and back end to fit a rachet sleeve joint;

rachet sleeve joints, respectively configured on the broad parts on the front and back end of the wrench shaft, and respectively configured with a one-sided or double-sided sleeve joint structure;

at least two sleeve joint structures configured on one single rachet wrench, so that the wrench can fit sleeves of multiple specifications.

One of the objectives and functions of the present invention is to allow one single rachet wrench to fit sleeves of multiple specifications or sizes through the configuration of multiple sleeve joint structures on the rachet wrench, so as to overcome the shortcoming of prior-art in that one wrench can only fit one sleeve of the same specification.

Another objective and function of the present invention is to considerably reduce the purchase cost and improve the convenience for replacement through a versatile structural design that allows the user to fit sleeve components of multiple specifications.

### BRIEF DESCRIPTION OF THE DRAWINGS

FIG. 1 is a perspective view of a prior-art rachet wrench.

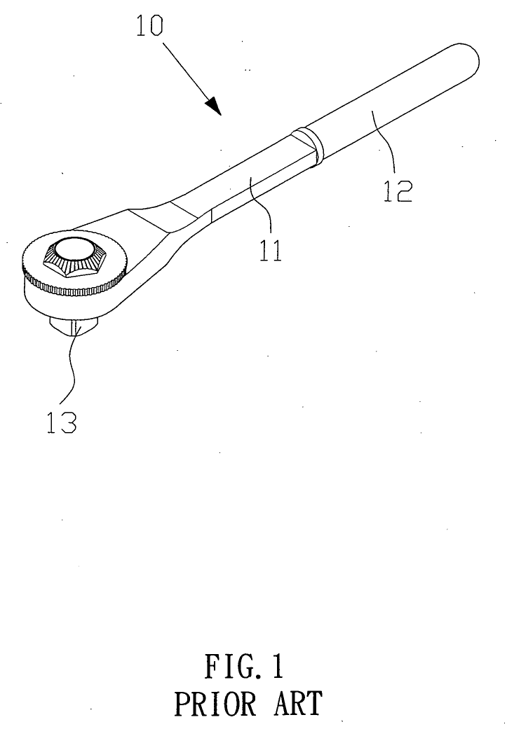

FIG. 2 is one perspective view of the present invention.

FIG. 3 is another perspective view of the present invention.

FIG. 4 shows another preferred embodiment of the present invention.

### DETAILED DESCRIPTION OF PREFERRED EMBODIMENTS

The features and the advantages of the present invention will be more readily understood upon a thoughtful deliberation of the following detailed description of a preferred embodiment of the present invention with reference to the accompanying drawings.

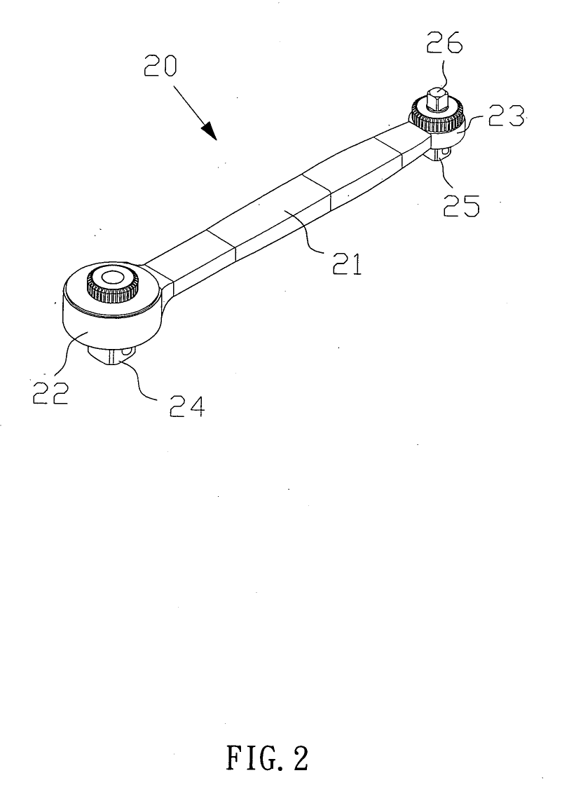

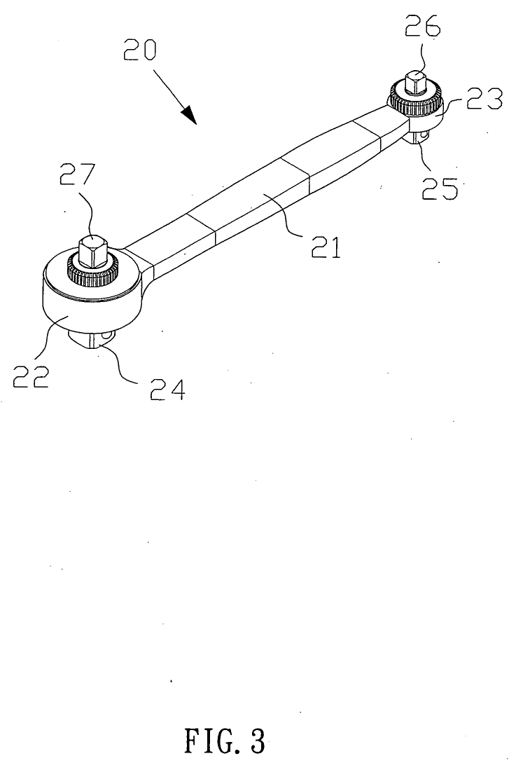

Referring to FIG. 2, in the structure of the rachet wrench 20 of the present invention, a broad part 22 23 is configured on both the front and back end of the wrench shaft 21 to fit the rachet sleeve joint 24 25, and one rachet sleeve joint 24 25 device is configured correspondingly; Further, referring to FIG. 3, the rachet sleeve joint 24 25 is attached with a joint 26 27, and each joint 24 25 26 27 is specified differently. In this way, sleeves of multiple specifications can work on one single rachet wrench 20.

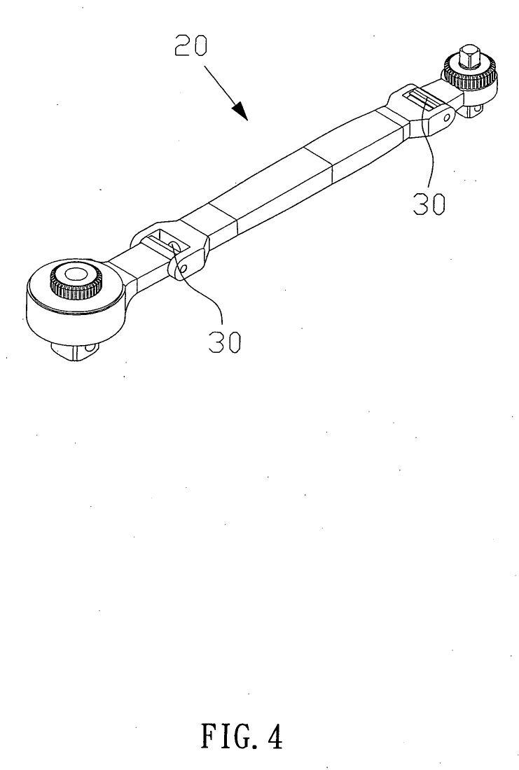

Moreover, referring to FIG. 4 for the structure of another preferred embodiment of the present invention, on a position close to the rachet sleeve joint 24 25 on the front and back end of the wrench shaft 21, a rotation gear 50 can be added, so as to allow rotation in different angles. In this way, when using the wrench, operation and manipulation can vary according to the working space or special needs.

To conclude, the multi-head rachet wrench of the present invention innovatively fits rachet sleeve joints and upper joints of various specifications on one single wrench, not only providing the user with convenience in operation and replacement of the sleeve, but also reducing the cost to purchase tools. Further, with the added rotation gear on the wrench shaft, the present invention can meet the demand for working space variation. On the whole, it has excellent economic benefit in industrial application and is indeed an exceptional and outstanding original design. Hence, a patent application is filed in accordance with applicable legal provisions.

What is claimed is:

1. A multi-head rachet wrench, mainly comprising:
a wrench shaft, configured with a broad part on both the front and back end to fit a rachet sleeve joint;
rachet sleeve joints, respectively configured on the broad parts on the front and back end of the wrench shaft, and respectively configured with a one-sided or double-sided sleeve joint structure;
at least two sleeve joint structures configured on one single rachet wrench, so that the wrench can fit sleeves of multiple specifications.

2. The structure defined in claim 1, wherein the sleeve joint structures are of different sizes and specifications.

3. The structure defined in claim 1, wherein a rotation gear is added respectively at a position close to the rachet sleeve joint on both end of the wrench shaft.
